(19) United States
(12) Patent Application Publication
(10) Pub. No.: US 2008/0088434 A1
(43) Pub. Date: Apr. 17, 2008

(54) Rapid disaster notification system

(76) Inventors: Russell Frieder, Santa Barbara, CA (US); Srirangam Kumaresan, Goleta, CA (US); Anthony Sances, Goleta, CA (US); Seong K. Mun, McLean, VA (US)

Correspondence Address: LAURA N. TUNNELL, P.O. BOX 6003, SANTA BARBARA, CA, 93160, US

(21) Appl. No.: 11/582,632

(22) Filed: Oct. 17, 2006

(51) Int. Cl. G08B 1/08; G08B 23/00

(52) U.S. Cl. 340/539.11; 340/539.13; 340/539.26; 340/573.1

(57) ABSTRACT

A system operable for detecting the exposure of a person or persons to a plurality of different hazards. The system comprises at least one wearable personal module, a fixed communication center and wireless linking means operable for providing wireless communication between a personal module and the communication center and between a personal module and other personal modules comprising the system. The personal module is operable for detecting exposure of the wearer to a hazard and includes computer means operable for evaluating the threat level of the hazard to the wearer. The personal module further includes telemetry means operable for communicating the threat level to the fixed communication center and/or other personal modules. The personal module includes a plurality of detectors operable for detecting the exposure of the wearer to one or more chemical, physical, biological or radiological hazards under field conditions. The fixed communication center is operable for receiving exposure data from one or more personal modules and communicating the exposure data to first responders.

### BACKGROUND OF THE INVENTION

1. Field of the Invention

The present invention relates to a system for monitoring exposure of personnel to biological, chemical, physical and radiological hazards and evaluating the threat level of such exposure to personnel.

2. Prior Art

During a disaster that affects multiple people, such as terrorist attacks, natural disasters, chemical spills, etc., the affected individuals can become confused as to the nature of the emergency, as well as to the proper actions to take in order to mitigate negative consequences. If such confusion becomes widespread, the actions of the affected individuals will be random and chaotic, and may ultimately lead to unnecessary injuries and deaths. Persons acting on poor or incorrect information are likely to hinder the efforts of emergency response personnel, and may inadvertently subject themselves to avoidable dangers. In the event of such a disaster, it would be beneficial if affected personnel were provided with a portable, wearable device that could provide the affected persons with information regarding how best to mitigate the negative effects of the emergency.

In addition to providing those affected by an emergency situation with relevant information, it is also desirable to notify a variety of emergency responders of the situation, and provide such responders with information regarding scope and severity of the threat. In order to most effectively prepare and administer a response, emergency workers need to know certain information regarding the location of the situation, the nature of the emergency, how many people have been affected, and the current status of the scene where the situation has occurred. It is additionally desirable to record certain data regarding the causes and severity of the event for future analysis.

In the event of an emergency situation that is distributed over a wide geographical area, it is beneficial to know the physical dimensions of the affected area, the location of the epicenter, as well as the severity gradient at various distances from the epicenter. First responder organizations such as the police, paramedics, the Department of Homeland Security, and the Federal Aviation Administration, can more effectively respond to a given emergency and can better prepare for future emergencies, if provided with precise data regarding the severity of the emergency as related to geography.

An example of such an emergency event would be the release of a dangerous chemical agent in an urban setting. Given this scenario, there would likely be a large number of affected people who initially may not understand the nature of the emergency, the geographical distribution of the threat, or what steps should be taken in order to minimize exposure to the chemical agent. A lack of critical information may cause affected individuals to transport themselves to locations with higher densities of the chemical agent, or may cause them to panic, hyperventilate, and increase their rate of intake of the harmful chemical. The victims of such an emergency situation would be benefited by the provision of a device that could immediately indicate in which direction to relocate in order to minimize exposure, and provide information on what medicines, substances, improvised air filters, etc., could be used to mitigate the effects of the harmful chemical.

In the event that the disaster comprises a release of a toxic chemical agent, emergency responders would likely include paramedics, police, hazardous material teams, military, personnel from the department of homeland security and medical personnel from nearby hospitals. These responders need information regarding the location where the toxic chemical agent has been released, the type of agent released, the time since the agent was first detected, the extent to which the agent has spread, the probability of injury to people within the contaminated area, as well as a variety of other parameters regarding the situation. Using such information, emergency responders could most effectively plan and execute a response to the chemical release. Such data will enable responders to arrive on the scene with the appropriate equipment, medicines, and antidotes, to combat the specific chemical that has been released. Additionally, medical personnel at local hospitals will be better prepared for the number of casualties and the specific types of injuries that have resulted from the chemical release.

A variety of devices have been devised for providing hazard exposure data. A table listing some U.S. Pat. Nos. relevant to the art area of the present invention is presented in TABLE I as follows:

TABLE I

| | |
|---|---|
| 5,831,526 | Atmospheric hazard detector network |
| 6,392,536 | Multi-sensor detector |
| 6,441,743 | Method and apparatus for determining hazard |
| | levels of chemical/biological/nuclear agents in an |
| | environment |
| 6,525,658 | Method and device for event detection utilizing |
| | data from a multiplicity of sensor sources |
| 6,559,769 | Early warning real-time security system |
| 6,608,559 | Danger warning and emergency response system |
| | and method |
| 6,630,892 | Danger warning system |
| 6,741,174 | Environment and hazard condition monitoring |
| | system |
| 6,747,562 | Identification tag for real-time location of people |
| 6,885,299 | Geopositionable expendable sensors and the use |
| | therefore for monitoring surface conditions |
| 6,919,821 | method and system for collecting meteorological |
| | data using in-vehicle systems |
| 6,930,596 | System for detection of hazardous events |
| 6,946,671 | System and method for identifying, reporting, |
| | and evaluating presence of substance |
| 6,992,580 | Portable communication device and |
| | corresponding method of operation |
| 7,034,677 | Non-specific sensor array detectors |

Table I provides examples of systems that have been disclosed for the gathering of various types of information that may be useful to first responders in the event of an emergency. There remains a need for a system operable for detecting the exposure of a person or persons to a hazard, evaluating the threat level of the detected hazard and communicating the information regarding the nature of the hazard, the distribution of the hazard and means for mitigating the toxic effects of the hazard to the exposed people and first responders.

### SUMMARY

The present invention is directed to a rapid automatic disaster notification system (RADNS) and a method for using the RADNS that substantially obviates one or more of the limitations of the related art. To achieve these and other advantages and in accordance with the purpose of the invention, as embodied and broadly described herein, the RADNS of the present invention comprises a plurality of wearable personal modules wirelessly linked to a fixed communications center, which, in combination, provide relevant information to the victims of a disaster and first responders. Each personal module is wirelessly linked to other nearby personal modules, as well as to the fixed communications center. The personal modules have multiple sensors therewithin that are capable of detecting the existence and severity of exposure to a hazard. The data from the sensors is both analyzed within each personal module and transmitted to surrounding personal modules and the fixed communications center. Each personal module contains computer means operable for analyzing the data from its own sensors, as well as that from the sensors on nearby units, and provide its wearer with visible and/or audible instructions regarding how to cope with the emergency situation.

The sensor data transmitted from the personal modules to the fixed communications center is used by emergency services to execute an appropriate and effective response. Upon receipt of information from the personal modules, the fixed communication center notifies emergency services and relevant government agencies of the disaster and identifies the particular hazard to which the victims may be exposed. The system can detect, transmit, and interpret information regarding many types of physically harmful disasters, including those that are manmade, natural, intentional, and accidental. The system is intended to quickly and efficiently transmit useful information to response teams, thereby minimizing both the total number of disaster victims as well as the expenditure of community resources.

More particularly, the invention provides a system operable for detecting the location and severity of a disaster. The system comprises one or more wearable personal modules, a fixed communication center and a wireless service provider operable for providing a communication link between one or more of the personal modules and the fixed communication center and between personal modules comprising the system. The personal module comprises: (a) a global position sensor operable for providing the geographical location of the personal module; and (b) one or more sensors operable for detecting exposure of the personal module to a harmful chemical, biological or radiological agent.

The personal module further comprises computer means operable for: (a) receiving a data signal from the sensor(s) indicating a detected level of exposure of the personal module to a detected chemical, biological or radiological agent; (b) comparing the detected level to known health effects attributed to known exposure levels of the agent; and (c) providing output data indicating the severity of the exposure to the agent to the health of a person wearing the personal module. In addition, the personal module may include programmable means operable for providing a wearer with instructions for action that will mitigate the effects of a particular detected hazard. The personal module further comprises a RF transmitter operable for transmitting the output data from the computer means to the fixed communication center and other personal modules comprising the system and a RF receiver operable for receiving output data from other personal modules comprising the system.

The features of the invention believed to be novel are set forth with particularity in the appended claims. However the invention itself, both as to organization and method of operation, together with further objects and advantages thereof may be best understood by reference to the following description taken in conjunction with the accompanying drawings.

### BRIEF DESCRIPTION OF THE DRAWINGS

FIG. 1 is a schematic block diagram of a wearable hazard detector module (i.e., personal module) in accordance with the present invention.

FIG. 2 is a schematic diagram illustrating one of the possible communication links between the personal module of FIG. 1 and: (a) a wireless service provider; (b) a central (fixed) communications center; and (c) a plurality of emergency service providers.

FIG. 3 is a map of a city showing the epicenter of a disaster and the positions of a plurality of personal modules disposed in or near the affected area. The signals from the detectors housed within respective personal modules serve to identify the area affected by the disaster.

### DESCRIPTION OF THE PREFERRED EMBODIMENTS

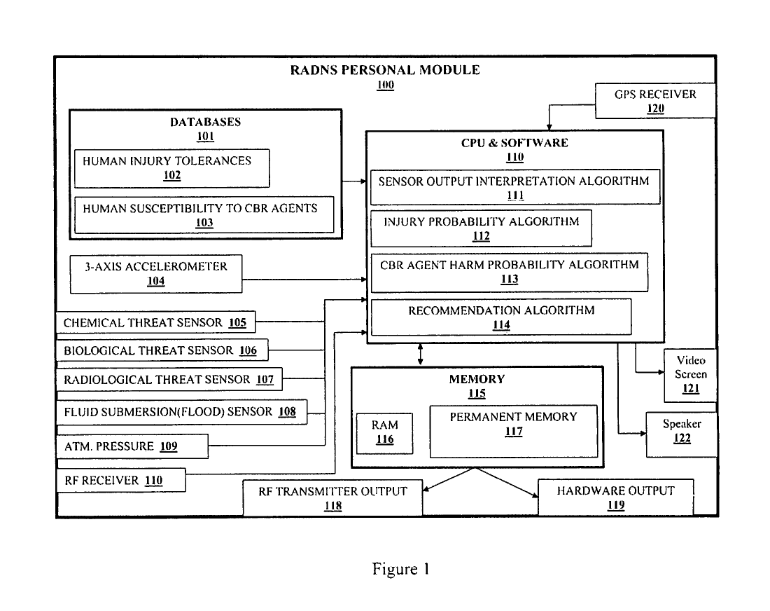

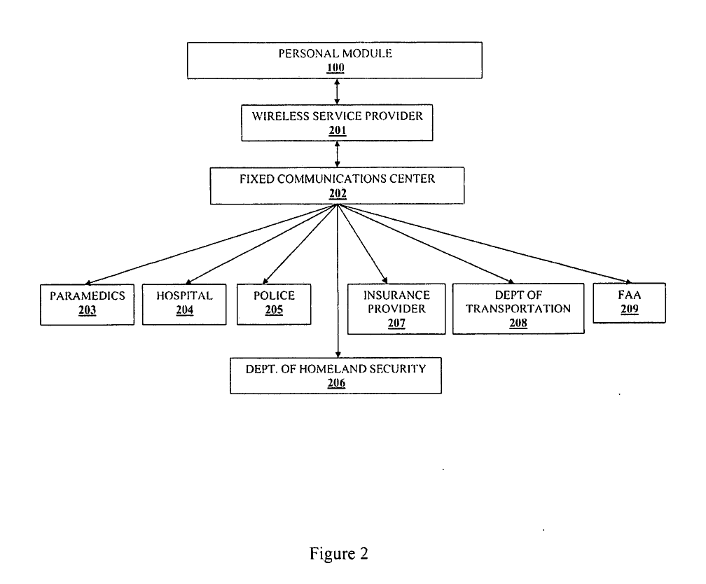

With general reference to FIGS. 1 and 2, the rapid automatic disaster notification system(RADNS) comprises a collection of wearable personal modules 100 and a fixed communications center 202, which, in combination, provide relevant information to the victims of a disaster and first responders. Each personal module is wirelessly linked to other nearby personal modules, as well as to the fixed communications center 202. The personal modules 100 each comprise multiple sensors (hazard detectors) that are capable of detecting the exposure to and severity of a multitude of environmental and traumatic conditions that are threatening to human health. The data from the sensors housed within each personal module 100 is analyzed by computer means within the personal module for enabling the wearer to formulate an appropriate response. The analyzed exposure data is also transmitted to surrounding personal modules and the fixed communications center 202. The analysis of exposure data from its own sensors, as well as that from the sensors on nearby personal modules, provides the wearer of each personal module 100 with visible and/or audible instructions on how to cope with the extant emergency.

The sensor data transmitted from the personal modules 100 to the fixed communications center 202 is used by emergency services to execute an appropriate and effective response. Upon receipt of information from the personal modules 100, the fixed communication center 202 notifies emergency services and relevant government agencies of the particular toxic substance and the exposure to the substance that has caused, or is likely to cause, harm to humans.

FIG. 1 is a block diagram illustrating the basic components of, and functions provided by each personal module 100. The personal module 100 is based around a central processing unit (CPU) which provides computer means and software 110 operable for interpreting data from environmental sensors 104-119 and stored databases 101, and provides the wearer with instructions for mitigating or avoiding impending danger. The databases 101 stored in the personal module 100 provide the CPU and software 110 with information regarding human injury tolerance 102 and human susceptibility to chemical, biological, and radiological (CBR) agents 103. The injury tolerance database 102 provides the CPU and software 110 with clinically observed reference values for injury to the human body. The human susceptibility to CBR agents database 103 provides the CPU and software 110 with reference values for injury to the human body based on exposure to a known set of chemicals, pathogens, toxins, and nuclear radiation. The sensors 104-109 incorporated within the personal module 100 include a 3-axis accelerometer 104, a chemical threat sensor 105, a biological threat sensor 106, a radiological threat sensor 107, a fluid submersion sensor 108, and an atmospheric pressure sensor 109. The radio frequency(RF) receiver 110 receives wireless signals from near by personal modules 100 and the fixed communications center 202 and outputs them to the CPU and software 110 for processing. The global positioning system (GPS) receiver 120 provides the CPU and software 110 with information regarding the geographical location and altitude of the personal module 100.

Using the inputs from the databases 101, the sensors 104-109, the RF receiver 110, and the GPS receiver 120, the CPU and software 110 first interpret the raw sensor output data using a sensor output interpretation algorithm 111. Once interpreted, the data from the accelerometer 104, the fluid submersion sensor 108, and the pressure sensor 109 are sent to the injury probability algorithm 112 where it is compared with the reference values from the human injury tolerances database 102. If the injury probability algorithm 112 determines that injury to the wearer of the module 100 is probable, the information is sent first to the recommendation algorithm 114 and then to the module's memory 115. The recommendation algorithm 114 evaluates the type and severity of the probable injury, and outputs a signal to the video screen 121 and speaker 122 that provides the wearer with instructions as to what actions should be taken to mitigate injury. Once the data is stored in the random access memory (RAM) 116 and permanent (i.e. FLASH) memory 117 of the personal module 100 it is wirelessly sent by the RF transmitter 118 to nearby personal modules 100 and the fixed communications center 202. The information can also be downloaded through the hardware output port 119 to a laptop or palmtop computer (not shown).

Once interpreted, the data from the chemical threat sensor 105, the biological threat sensor 106, and the radiological threat sensor 107 are sent to the CBR agent harm probability algorithm 113 where it is compared with the reference values from the human susceptibility to CBR agents database 103. If the CBR agent harm probability algorithm 113 determines that the wearer of the module 100 has been exposed to a harmful dose of a chemical, biological, or radiological agent, the information is sent first to the recommendation algorithm and then out to the module's memory 115. The recommendation algorithm 114 evaluates the type of harmful agent to which the wearer has been exposed, as well as the dose to which the wearer has been exposed, and outputs a signal to the video screen 121 and speaker 122 that provides the wearer with instructions as to what actions he/she should take. For example, depending on the specific threat, the video and audio instructions could indicate if any commonly available substances can be used for decontamination, if the agent should be scraped or washed from the skin or left alone, if the agent is likely to accumulate near the ceiling or near the floor, or a variety of other situation specific recommendations. The recommendation algorithm 114 also takes into account information received from nearby personal modules 100, information received from the fixed communications center, and location data from its internal GPS receiver 120 to provide the wearer with directions for relocation to a less harmful environment. In the case of a chemical release, chemical threat data from nearby modules will allow the recommendation algorithm 114 to direct the wearer to a location with a lower density of the harmful chemical. Data stored in the module's 100 RAM 116 and permanent memory 117 is wirelessly sent by the RF transmitter 118 to nearby personal modules 100 and to the fixed communications center 202. The information can also be downloaded through the hardware output port 119 to a laptop or palmtop computer.

Turning now to FIG. 2, an example of a possible chain of communication between a single personal module 100, a wireless service provider 201, the fixed communications center 202, and a variety of emergency response services 203-209 is illustrated. In the event of a disaster, each personal module 100 continually transmits its interpreted sensor data and location to the fixed communications center 202 via a wireless service provider 201. The transmissions of multiple personal modules 100 can then be used by the fixed communications center 202 to determine a variety of critical parameters regarding the disaster. Such parameters may include, but are not limited to, the type (chemical, biological, bomb blast, flood, etc.) of disaster present, the epicenter of the affected area, the boundaries of the affected area, the severity gradient with respect to location, the severity gradient with respect to time, and the approximate number of people affected. Such parameters, as well as additional information available only to the fixed communications center 202, can then be sent back to the personal modules 100 to improve the recommendations provided to the wearer of each unit. The accuracy and resolution of the calculated parameters is dependent on the number of personal modules transmitting data from different locations. These critical parameters are also transmitted from the fixed communications center 202 to relevant emergency and non-emergency services that may include paramedics 203, hospitals 204, police 205, the Department of Homeland Security 206, insurance providers 207, the Department of Transportation 208, and the Federal Aviation Administration 209. Such groups can then overlay the supplied parameters onto a map of the affected area in order to effectively plan and execute a response to the emergency situation.

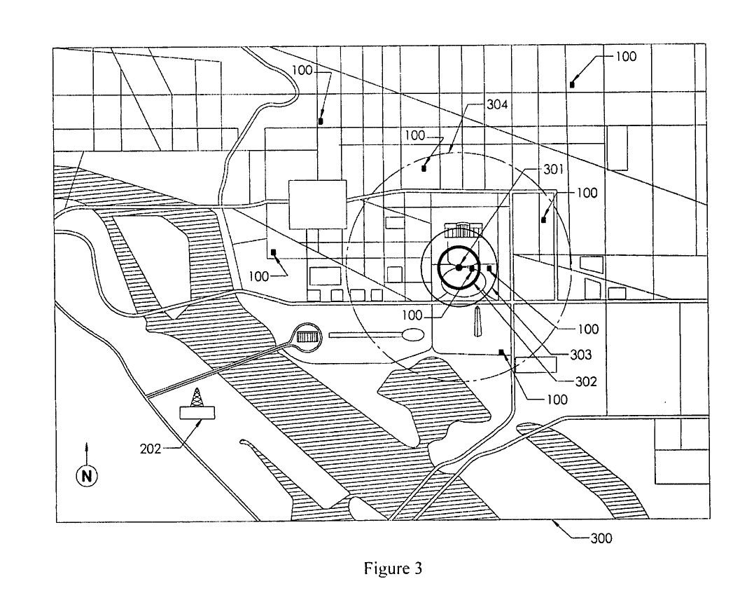

An example of how the RADNS of the present invention can be used as a tool for victims of a disaster and first responders is illustrated in FIG. 3. FIG. 3 is a depiction of an overhead map 300 of a representative metropolitan city that has been the subject of a fictitious terrorist attack. Overlaid onto the map are the locations of multiple personal modules 100 depicted as dark rectangles, the epicenter 301 of the attack depicted as a dark circular dot, with concentric rings of severity 302, 303, 304 centered thereon. Depending on the nature of the attack, rings 302-304 could respectively represent decreasing densities of a chemical agent, a biological agent, radioactivity, etc. Also shown is a possible location for the fixed communications center 202. While FIG. 3 depicts the fixed communications center 202 as being near the exemplary metropolitan city, it is understood that the fixed communications center 202 can be located elsewhere, or even centrally with respect to the North American continent.

It can be seen from the map 300 that in the event of such a disaster the various personal modules 100 will each sense, interpret, record, and transmit environmental data that is unique to the grographic coordinates of the particular personal module. With access to a collection of information provided by the sensors in each personal module sensors, the sensors of nearby personal modules 100, and that transmitted from the fixed communications center 202, each personal module 100 will direct its wearer in a direction radial to, and away from the estimated epicenter of the attack.

The map 300 is also representative of one that could be created by overlaying the location and severity data from the individual personal modules 100 over a map of the affected area. Such a map 300 would offer emergency groups 203-206 an improved method for determining the locations of victims and the geographical area covered by the disaster, and would also allow for the implementation of efficient triage. Because emergency response services have access to the probable severity of injury to each wearer of a personal module 100, they can efficiently categorize the victims of the disaster according to medical need prior to arriving at the scene. Responders will immediately seek out the locations of victims whose personal modules 100 have indicated probable, but treatable, injuries, and give lower priority to the areas where signals from personal modules 100 indicate that there is no possibility of human survival. With respect to map 300, emergency responders may be able to treat the wearers of personal modules 100 that lay outside severity ring 302 first, with the understanding that there are likely no survivors residing within severity ring 302. This prospect of advanced triage may ultimately lead to a minimization of victim deaths, and an improvement of rescued patient outcome, when compared to the currently used methods of triage.

The map 300 may also be used by non emergency services 207-209 in order to initiate a long term response to the disaster, or in order to better plan for similar future situations. For example, the FAA 209 may be able to use such information to immediately redirect flights around the site of the disaster, or determine if the occupants and structures of nearby airports have been compromised. Insurance providers 207 may also be able to use the information to immediately begin evaluating damage, and possibly to prevent the payment of fraudulent claims from person's who were near, but not actually affected, by the disaster.

The system (RADNS) can detect, transmit, and interpret information regarding many types of physically or biologically harmful disasters, including those that are man-made, natural, intentional, or accidental. The system is intended to quickly and efficiently transmit useful information to response teams, thereby minimizing both the total number of disaster victims as well as the expenditure of community resources. The personal modules 100 are small devices that can be stowed in a person's pocket, similar to a cell phone or a digital music player. As the miniaturization of sensors and integrated circuits progresses, the personal modules 100 may eventually be worn on the arm, in the manner of a wristwatch.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What we claim is:

1. A system operable for detecting the location and severity of a disaster comprising one or more wearable personal modules, a fixed communication center and a wireless service provider operable for providing a communication link between one or more of said personal modules and said fixed communication center and between personal modules comprising said system.

2. The system of claim 1 wherein said personal module comprises: (a) a global position sensor operable for providing the geographical location of said personal module; and (b) one or more sensors operable for detecting exposure of said personal module to a harmful chemical, biological or radiological agent.

3. The system of claim 2 wherein said personal module further comprises computer means operable for: (a) receiving a data signal from said sensor indicating a detected level of exposure of said personal module to a detected chemical, biological or radiological agent; (b) comparing said detected level to health effects of known exposure levels of said agent; and (c) providing output data indicating severity of the exposure to the agent to the health of a person wearing said personal module.

4. The system of claim 3 wherein said personal module further comprises a RF transmitter operable for transmitting said output data to said fixed communication center and other personal modules comprising said system.

5. The system of claim 4 wherein said personal module further comprises a RF receiver operable for receiving said output data from other personal modules comprising said system.

6. The system of claim 3 wherein when said personal module detects a hazard, said computer means is operable for providing an instruction for personal action that will mitigate the effect of said detected hazard on a person.
